(19) United States
(12) Patent Application Publication
(10) Pub. No.: US 2012/0280977 A1
(43) Pub. Date: Nov. 8, 2012

(54) Method for Three-Dimensional Display and Associated Apparatus

(75) Inventor: Kun-Nan Cheng, Zhubei City (TW)

(73) Assignee: MSTAR SEMICONDUCTOR, INC., Hsinchu Hsien (TW)

(21) Appl. No.: 13/307,160

(22) Filed: Nov. 30, 2011

(30) Foreign Application Priority Data
May 2, 2011 (TW) 100115386

(51) Int. Cl. G06T 15/00

(52) U.S. Cl. 345/419

(57) ABSTRACT

A method and apparatus for 3D display displays 3D images and senses a user response to the 3D images to obtain positioning information corresponding to the 3D images.

This application claims the benefit of Taiwan application Serial No. 100115386, filed May 2, 2011, the subject matter of which is incorporated herein by reference.

### BACKGROUND OF THE INVENTION

1. Field of the Invention

The invention relates in general to a method for three-dimensional (3D) display and associated apparatus, and more particularly to a method integrating 3D images and sensing positioning and associated apparatus.

2. Description of the Related Art

The 3D display technique capable of displaying 3D images offer users with more vivid and diversified perception experiences and is thus one of the research focuses of modern information developers.

To display a 3D image of an object, a 3D display respectively presents a left image and a right image to a left eye and a right eye of a viewer, and a formed 3D image is perceived by the viewer due to a parallax between the left image and the right image.

However, there are various factors that affect a position of the 3D image perceived by the viewer, and a difference also exists between a position of the 3D image that 3D image information wishes to present via the parallax and a position of the 3D image actually perceived by the viewer. Thus, not only a playback quality of the 3D is degraded but also a viewer may become unable to appropriately interact with the 3D image.

### SUMMARY OF THE INVENTION

The invention is directed to a technique integrating an image formation position of a 3D image and a position of a viewer, so that the viewer is capable of appropriately interact with a virtual environment constructed by the 3D image.

According to an object the present invention, a method applied to a 3D display is provided. The method comprises: displaying a 3D image of one or a plurality of test objects by the 3D display, the 3D image of each test object being associated with a predetermined parallax offset; and sensing a response signal from a user in response to the 3D image of the test object, and sensing test positioning information (including a distance between the 3D image and a monitor) of the user. Between the predetermined parallax offset and the test positioning information is a predetermined relationship, so that positioning information corresponding to different parallax offsets may be represented by a functional relationship.

The present invention allows a user to interact with the 3D image by utilizing the functional relationship between the parallax offset and the positioning information. For example, 3D images of a predetermined number of interactive objects are displayed by the 3D display, with the 3D image of each interactive object being associated with a predetermined procedure and corresponding to a second parallax offset. The second parallax offsets are substituted into the functional relationship to provide corresponding reference positioning information. Interaction positioning information of the user in response to the 3D images of the interactive objects is sensed by a sensor, and the interaction positioning information is compared with reference positioning information corresponding to the interactive objects. When the interactive position information matches with the reference positioning information corresponding to one of the interactive objects, the 3D display then executes the predetermined procedure associated with the matching interactive object.

In other words, the 3D display is capable of displaying a plurality of 3D virtual interactive objects through the 3D images, and predicting a position of a formed 3D image (i.e., reference positioning information) according to correction based on the functional relationship. When the user interacts with the interactive objects, the sensor senses the reference positioning information according to a movement of the user. When the sensed interaction positioning information matches with the reference positioning information of a matching interactive object, the 3D display then executes the procedure associated with the matching interactive object to thereby allowing the user with 3D interactions with respect to the 3D display.

In an embodiment, when a comparison result indicates the interaction positioning information does not match with any reference positioning information, a prompt is sent to command the user to adjust a user position, and the interaction positioning information of the user is again sensed.

In another embodiment, when the comparison result indicates the interaction positioning information does not match with any reference positioning information, an interaction parallax offset is provided according to the user interaction positioning information and a predetermined relationship, so that the parallax offset of the 3D image of the interactive object equals the interaction parallax offset to match with the corresponding reference positioning information with the user interaction positioning information.

In an embodiment, the sensor comprises a plurality of lenses. The lenses capture an image of the user to generate a plurality of sensed images and provide sensed positioning information according to differences between the sensed images. The differences between the sensed images may also be utilized for focusing when generating the sensed images.

In an embodiment, the sensor comprises a transmitter and a receiver. The transmitter transmits a positioning wave to a user, and the receiver receives a reflected wave of the positioning wave. Sensed positioning information may be provided according to the reflected wave. For example, the positioning wave is an electromagnetic wave, an infrared wave, a sound wave, an ultrasonic wave or a shock wave.

The present invention predicts an expected 3D image position to be sensed by the user via a functional relationship between a parallax offset and positioning information to adjust the 3D image, so that the user may sense the 3D image at the expected position. When presenting a displayed image, supposing the user wishes to sense a 3D image of the displayed image at a predetermined display position, display positioning information corresponding to the display position is substituted into the functional relationship to obtain a corresponding display parallax offset. Thus, a 3D display displays the 3D image of the displayed object according to the display parallax offset so that the user is allowed to perceive the 3D image of the displayed object at the display position.

For example, the 3D display comprises a plurality of speakers. The present invention adjusts playback parameters of the speakers according to the positioning information sensed by the sensor to correct a 3D sound field of the speakers, so that the user is able to sense due surround audio effects at the expected position.

According to another object the present invention, a method applied to a 3D display is provided. The method comprises: displaying a plurality of test 3D images by the 3D display, each test 3D image corresponding to a predetermined parallax offset; and obtaining corresponding test positioning information according to a response signal of a user in response to each test 3D object. A functional relationship is calculated according to each predetermined parallax offset and the test positioning information to associate different parallax offsets to the corresponding positioning information.

The functional relationship may be utilized to adjust/correct the 3D image. The adjustment/correction comprises: obtaining display image data, the display image data comprising a second predetermined number of 3D display images respectively corresponding to display positioning information; substituting the display positioning information into the functional relationship to respectively provide a corresponding display parallax offset; and adjusting the 3D display images of the 3D image data according to the display parallax offsets to allow a user to perceive the 3D display images at display positions corresponding to the display positioning information.

The present invention further corrects a 3D image by utilizing a surround sound field. When displaying the test 3D images, a second predetermined number of test audio data are played by the 3D display, with each audio test data corresponding to each of a plurality sets of predetermined audio effect offset information. A functional relationship is calculated according to the predetermined audio effect offset information and the test positioning information to describe positioning information corresponding to different audio effect offset information. The functional relationship may be utilized to correct/adjust audio data to match with surround audio effects corresponding to the audio data to a virtual environment constructed by the 3D image. When display audio data to be adjusted/played is obtained, display positioning information corresponding to the display audio data is substituted into the functional relationship to provide corresponding display audio effect offset information. Thus, the display audio data may be adjusted according to the display effect offset information.

According to yet another object the present invention, a 3D playback apparatus is provided. The apparatus comprises an image processing module, an image correction module, an image adjustment module, an audio processing module, an optional audio correction module, and an optional audio adjustment module. The image processing module receives a predetermined number of test 3D images and obtains a predetermined number of predetermined parallax offsets each associated with one of the test 3D image. The image correction module receives parallax offsets, and receives test positioning information corresponding to each of the predetermined parallax offsets. The test positioning information is provided by a sensor, and corresponds to a user response to the test 3D images. The image correction module further calculates a functional relationship according to the predetermined parallax offsets and the test positioning information to associate the different parallax offsets to the corresponding positioning information.

The image adjustment module receives display image data corresponding to second predetermined sets of display positioning information. The image correction module substitutes the display positioning information into the functional relationship, and provides a display parallax offset corresponding to the display positioning information to the image adjustment module. The image adjustment module further adjusts the display image data according to the display parallax offsets.

The audio processing module receives predetermined sets of predetermined audio offset information associated with a predetermined number of test audio data and test 3D images. The audio correction module receives the test positioning information and second predetermined sets of predetermined audio offset information associated with the test audio data and the 3D images. The audio correction module calculates a second functional relationship according to the predetermined audio offset information and the test positioning information to associate the audio offset information to the corresponding positioning information.

The display image data further associates with a display audio data corresponding to second display positioning information. The audio correction module substitutes the second display positioning information into the second functional relationship to provide associated display audio offset information. The image adjustment module then adjusts the display image data according to the display parallax offsets and the display audio offset information.

The audio adjustment module receives the display audio data and the display audio offset information provided by the audio correction module. The audio adjustment module adjusts the display audio data according to the display audio offset information and the display parallax offsets.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIGS. 1A to 1C are schematic diagrams illustrating a relationship between a parallax offset and a position of a formed 3D image.

FIGS. 2A, 2B, 3A and 3B are schematic diagrams illustrating factors affecting a position of a formed 3D image.

FIGS. 4A to 4C are schematic diagrams of sensing positioning according to an embodiment of the present invention.

FIG. 5 is a flowchart of a flow for correcting a position of a formed 3D image by sensing positioning according to an embodiment of the present invention.

FIG. 6 is a flowchart of realizing 3D interaction according to an embodiment of the present invention.

FIG. 7 is a schematic diagram of a 3D sound field established according to an embodiment of the present invention.

FIG. 8 is a flowchart of a flow for correcting 3D sound field by sensing positioning according to an embodiment of the present invention.

FIG. 9 is a schematic diagram of an apparatus for 3D playback according to an embodiment of the present invention.

### DETAILED DESCRIPTION OF THE INVENTION

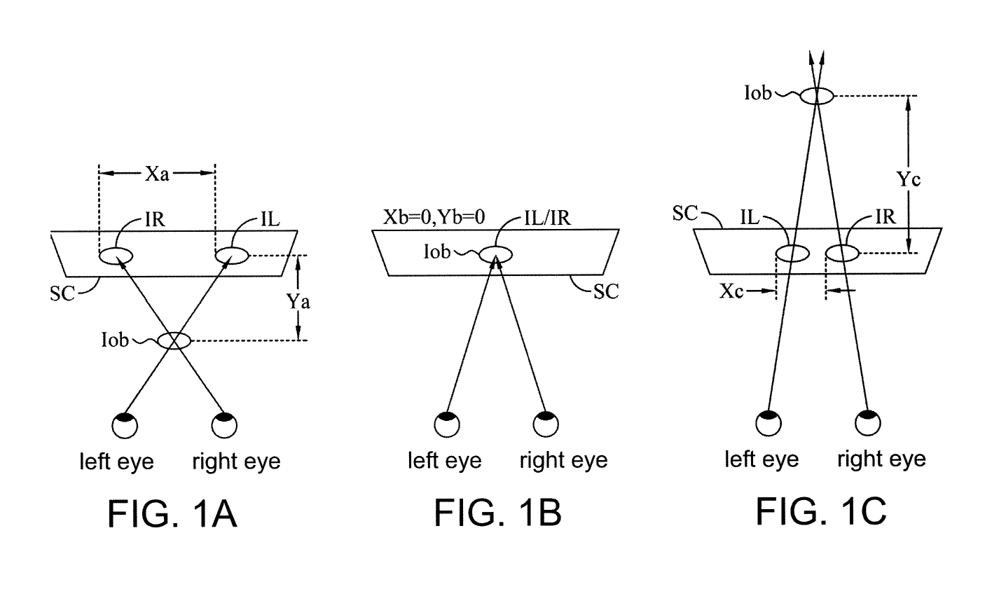

An offset between a left image and a right image is commonly referred to as a 3D depth, and is associated with a position of a formed 3D image perceived by a viewer. FIGS. 1A to 1C shows different positions of 3D images formed according to different offsets. As shown in FIG. 1A, on a monitor SC, a left image IL of an object is located closer to the right side of the monitor, and a right image IR is located closer to the left side of the monitor. Therefore, an offset Xa exists in between the right image and the left image. Due to the offset Xa between the two images, a formed image ‘lob’ of the object is presented in front of a monitor SC with a distance Ya apart from the monitor SC. Assuming a position of a viewer stays unchanged and the offset Xa is reduced by respectively moving the left image IL and the right image IR towards the center, the distance Ya is also reduced such that the 3D image ‘lob’ gradually approaches the monitor SC. As shown in FIG. 1B, when an offset Xb between the left image IL and the right image IR is 0, the formed 3D image 10b exactly falls on the monitor SC, that is, the distance Yb from the monitor SC is 0. As shown in FIG. 10, when the left image IL is closer to the left and the right image IR is closer to the right, the formed image lob is located behind the monitor SC due to an offset Xc between the two images, such that the formed image lob is at a distance Yc from the monitor SC.

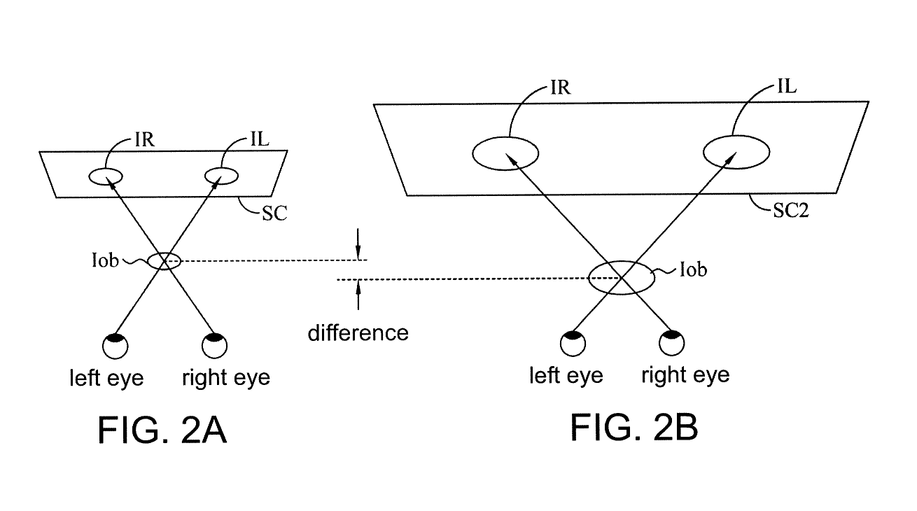

It is observed from the examples from FIGS. 1A to 1C that, a position of the formed 3D image (a position relative to the monitor or the user) may be adjusted by changing the offset between the left and right images. However, there are other factors that affect the position of the formed 3D image—FIGS. 2A and 2B as well as 3A and 3B respectively illustrate some of the factors that affect the positions of the formed 3D image.

One of the factors affecting the position of the formed 3D image is size of the monitor. In FIG. 2A, the left and right images IL and IR are displayed on a smaller monitor SC; in FIG. 2B, the left and right images IL and IR are proportionally displayed on a larger monitor SC2, in a way that an offset between the two images is also proportionally increased. Although a distance between a viewer and the monitor is unchanged, the presented formed 3D image lob is closer to the viewer when the monitor is the larger monitor SC2.

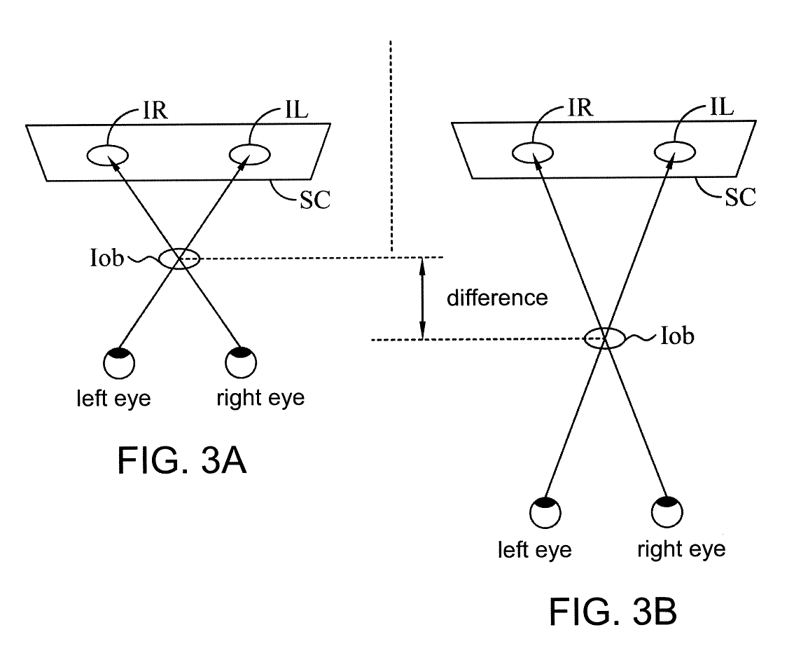

Another factor affecting the position of the formed 3D image is a distance between the viewer and the monitor. In FIGS. 3A and 3B, the left and right images IL and IR are both displayed on the same sized monitor SC, and an offset between the two images are also the same. Referring to FIG. 3B, a distance between the viewer and the monitor is greater than that shown in FIG. A, such that the position of the formed 3D image is also changed. Further, other factors such as a distance between the eyes of the viewer also affects a distance (position) of the formed 3D image presented.

It is concluded from the above discussion that a position of a 3D image perceived by a viewer is affected by various factors. As a result, a 3D image position intended by a parallax offset carried in 3D image data may actually differ from a 3D image position perceived by the viewer. Not only a playback quality of the 3D image is undesirably affected but also a user is hindered from appropriate interactions with the 3D image.

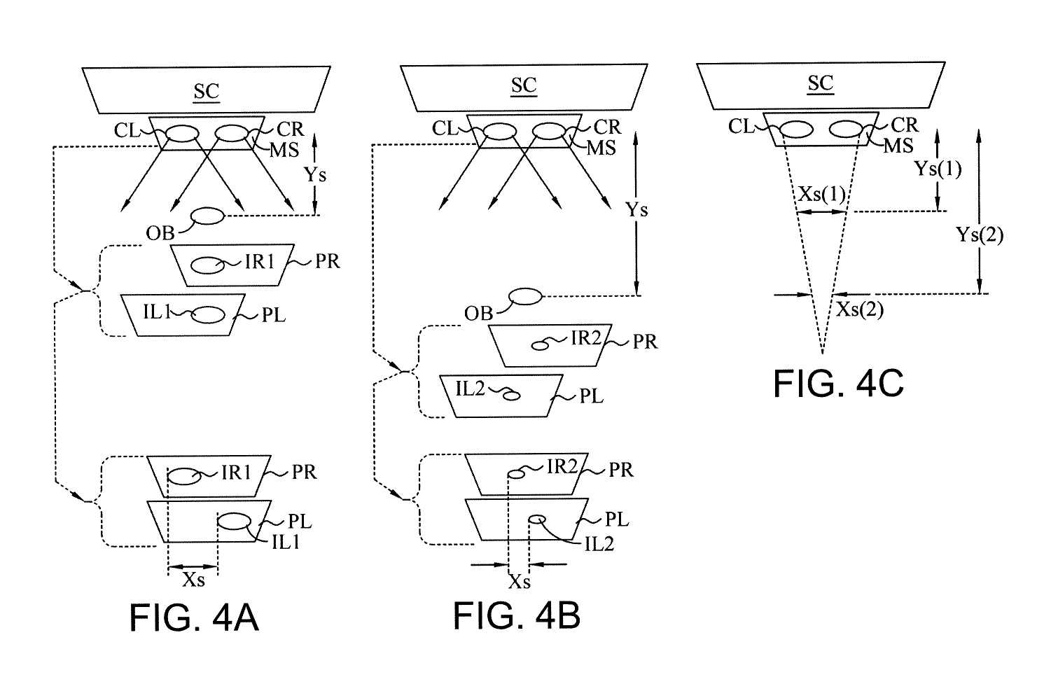

According to an embodiment of the present invention, a 3D display technique of a 3D display provides a 3D depth sensation to a viewer, senses a position of a monitor relative to the viewer by a sensor, and integrates a position of a formed 3D image and the viewer position to offer the viewer with interactions with the 3D image played by the 3D display. FIGS. 4A to 4C shows schematic diagrams of sensing and positioning according to an embodiment of the present invention. To realize the present invention, a 3D display monitor SC comprises or cooperates with a sensor MS, e.g., a (video) camera. In the embodiment shown in FIGS. 4A to 4C, the sensor MS comprises a left camera lens CL and a right camera lens CR. Referring to FIG. 4A, for an object OB located at a distance Ys from the sensor MS, e.g., a viewer being captured in front of the monitor, a left image IL1 of the object OB captured by the left camera lens CL is located on a left screen PL, and a right image IR1 of the object OB captured by the right camera lens CR is located on a right screen PR. Due to a difference between positions of the left and right camera lenses PL and PR, an offset Xs is generated between the left and right images IL1 and IR1 on the left and right screens PL and PR.

Referring to FIG. 4B, the two camera lenses of the sensor are analogically the two eyes of a person. Supposing the distance Ys between the object OB and the sensor MS increases, the offset Xs between left and right images IL2 and IR2 decreases when the left and right images IL2 and IR2 of the object OB are captured by the left and right camera lenses CL and CR. Therefore, the position (e.g., the distance Ys) of the object OB is associated with the difference (e.g., the offset Xs) between the left and right images of the object OB. Referring to FIG. 4C, a larger offset Xs(1) corresponds to a smaller distance Ys(1), and a smaller offset Xs(2) corresponds to a larger distance Ys(2), meaning that a functional relationship exists between the offset and the distance. The functional relationship is associated with a size of the 3D display monitor SC; that is, the functional relationship varies with the size of the monitor. According to the offset Xs between the left and right images, the sensor MS determines a relative position (e.g., a distance from the sensor MS) of the object OB, and provides positioning information corresponding to the object OB, including the distance Ys. In an embodiment, the sensor MS may also perform focusing according to the offset between the left and right images. That is, it is determined whether appropriate focusing on the object is achieved according to the offset between the left and right images when capturing the object.

In another embodiment (not shown) of the present invention, the sensor may be one or a plurality of transmitters and one or a plurality of receivers in replacement of the camera. The transmitter transmits a positioning wave to the object and the receiver receives a reflected wave of the positioning wave. According to the reflected wave (e.g., by comparing a difference between the positioning wave and the reflected wave, or by comparing the reflected wave received by different receivers), the sensed positioning information may be provided. For example, the positioning wave is an electromagnetic wave, an infrared wave, a sound wave, an ultrasonic wave or a shock wave.

According to the viewer/user position obtained by the sensor and considering the formed 3D position actually perceived by the user, the 3D display system of the present invention adjusts the formed 3D image position and/or adjusts the user position, so that the user is able to correctly perceive (via eyes or body gesture) the formed 3D image and further interact with the 3D image, thereby providing a realistic ambience with the virtual environment.

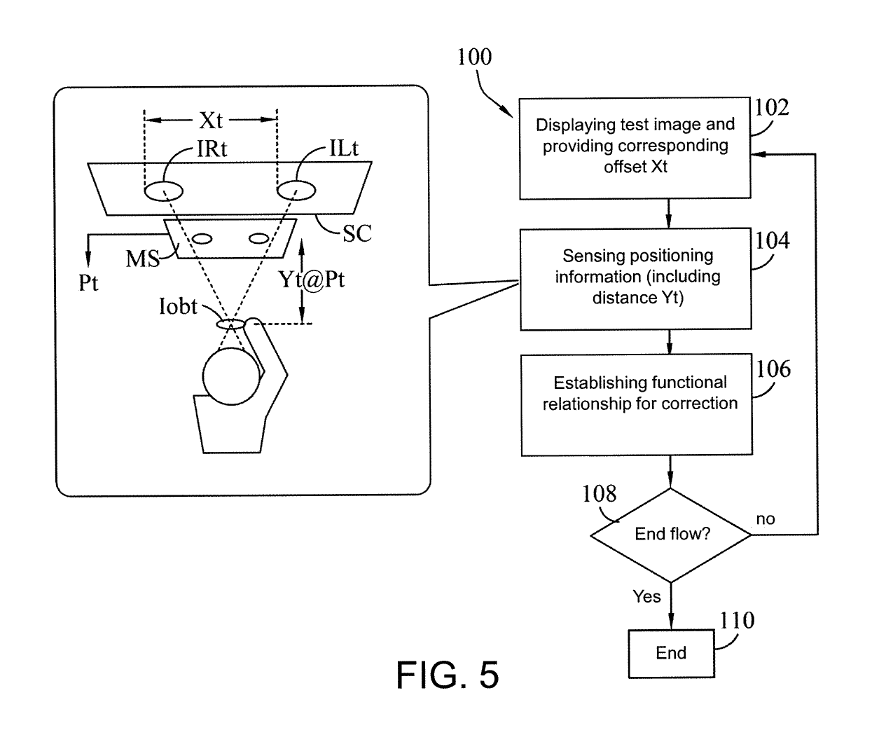

FIG. 5 shows a flowchart of a flow 100 according to an embodiment of the present invention. The flow integrating 3D display and sensing positioning shall be described below.

In Step 102, a test 3D image is displayed. For example, left and right images ILt and IRt of an object are generated on a 3D display monitor. Between the left and right images ILt and IRt is a parallax offset Xt, and a formed image ‘lobt’ is perceived by a user. That is, the formed image lobt serves as a test 3D image.

In Step 104, the 3D display prompts the user to provide a specific response signal if the 3D image ‘lobt’ is perceived as clear, e.g., response actions including gestures, touching or flapping the formed 3D image perceived. Alternatively, in another embodiment, the user actively provides a response signal when the formed 3D image is perceived as clear. In an embodiment, the sensor MS senses test positioning information Pt, which comprises a distance Yt between the user of the sensor and the sensor. In an embodiment, the sensor MS senses a predetermined response of the user and senses a position of the predetermined response to obtain the positioning information Pt. In another embodiment, the predetermined response of the user is transmitted to the 3D display via other approaches, e.g., transmitting the response by pressing a button on a remote control.

More specifically, the sensor MS senses the test positioning information Pt via edges and/or positions of reference points (e.g., a body, shoulders and/or arms, and fingers) of the user. For example, left and right images are generated from capturing the user image by the camera lenses CL and CR in FIG. 4, and the test positioning information Pt is then provided according to a difference between the left and right images.

In Step 106, a functional relationship between the parallax offset Xt of the test 3D image and the distance Yt of the test positioning information Pt is established. The functional relationship describes positioning information corresponding different parallax offsets. In practice, Steps 102 and 104 are repeatedly iterated. For example, a 3D image with a different parallax offset Xt is adopted in each iteration of Step 102 to generate a formed image lobt at a different position. In Step 104, different positioning information Pt and distances Yt corresponding to different parallax offsets Xt are sensed according to actual user sensations to accumulate a plurality of relationships between the parallax offset Xt and the distance Yt, so as to derive a general functional relationship between the two.

In Step 108, it is determined whether the accumulation of the corresponding relationship between the parallax offset Xt and the distance Yt is to be further continued. When a result is affirmative, i.e., the accumulation is yet to be further continued, Steps 102 and 104 are iterated. When a result indicates that the functional relationship between the parallax offset and the distance/positioning information is established, the flow 100 proceeds to Step 110.

The flow 100 ends in Step 110.

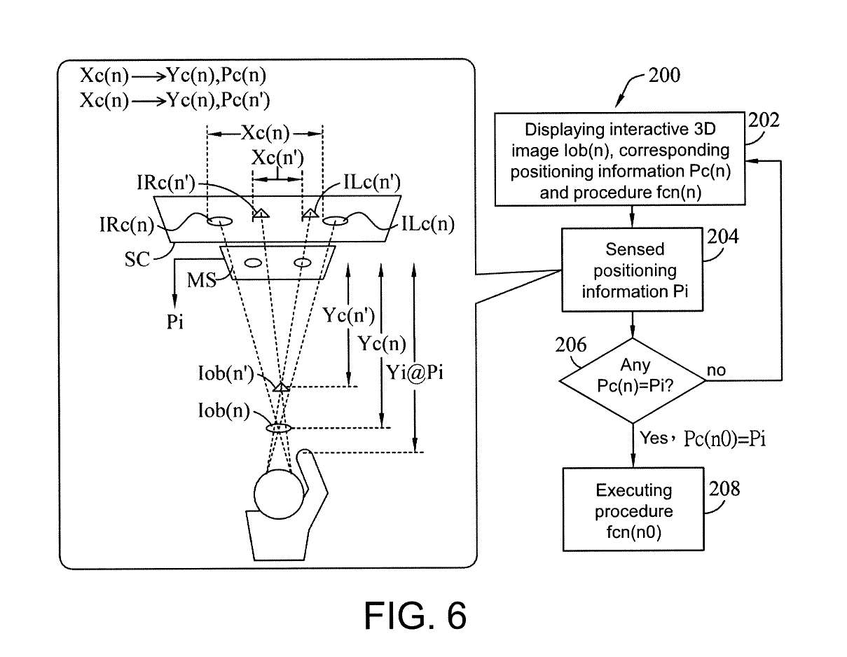

Through the functional relationship obtained in Step 100, the present invention allows the user to appropriately interact with a virtual object/environment of the 3D image. FIG. 6 shows a flow 200 of interacting with a 3D virtual environment according to an embodiment of the present invention.

In Step 202, an image or images (e.g., formed images lob(n) and lob(n′)) of one or a plurality of interactive objects are displayed on a 3D display monitor SC. The formed image lob(n) is formed by left and right images ILc(n) and IRc(n), between which is a corresponding parallax offset Xc(n). The parallax offset Xc(n) is substituted into the functional relationship in Step 106 to provide a corresponding distance Yc(n) and reference positioning information Pc(n). The formed image lob(n) is associated with a predetermined procedure fcn(n), which is executable by the 3D display, e.g., displayed brightness and contrast adjustment, pause, continue to play, or chapter selection. Further, the 3D display may also play a content provided by a host, and the predetermined procedure fcn(n) may be an operation executable by the host. For example, the host is a game console. When executing the predetermined procedure, a displayed content provided by the game console may be changed to offer varieties in a 3D virtual environment displayed by the 3D display and thereby interacting the user in response to user triggers.

In Step 204, interaction positioning information Pi of the user is sensed.

In Step 206, the interaction positioning information Pi is compared with the reference positioning information Pc(n) of the formed image lob(n). When a comparison result indicates the interaction positioning information Pi matches with reference positioning information Pc(n0) of a predetermined interactive object, the flow 200 continues to Step 208; or else, the flow 200 iterates Step 204 to continue to sense subsequent actions of the user. Performing Step 206 in this embodiment is to obtain a predetermined object (i.e., a predetermined 3D image) that the user wishes to touch among the numerous objects in the 3D interactive environment.

In Step 208, as the interaction positioning information Pi matches with the reference positioning information Pc(n0), e.g., when an error between the two is within a predetermined tolerable range, the 3D display executes the associated predetermined procedure fcn(n0). More specifically, when the interaction positioning information Pi matches with the reference positioning information Pc(n0), it means that the user response corresponds to the 3D image at the position Pc(n0).

In an embodiment, when the interaction positioning information of the user does not match with any reference positioning information of any interactive objects, it may mean that the user does not wish to initiate any interaction. For example, when an interaction is triggered, the user may want to adjust a sitting posture, pick up a phone or have a drink instead of triggering 3D interaction; it is concluded from comparing the interaction positioning information that user does not mean to trigger any predetermined procedure. Further, in the presence of a plurality of interactive objects (e.g., interactive formed images), the user is allowed to interact with one or some of the interactive objects.

In an embodiment, when the comparison results indicates the interaction positioning information does not match with any of the reference positioning information, the user may be prompted to adjust the user position to again sense the interaction positioning information of the user.

In another embodiment, when the comparison results indicates the interaction positioning information does not match with any of the reference positioning information, an interaction parallax offset may be provided according to the user interaction positioning information and a predetermined relationship, so that the parallax offset of the 3D image of the interactive object equals the interaction parallax offset to match with the corresponding reference positioning information with the user interaction positioning information.

Having performed the flow 100, the functional relationship between the parallax offset X of the 3D image and the distance Y actually sensed by the user may be established. When displaying the formed image lob(n) in Step 202, a position and a distance at/from which the user perceives the formed image lob(n) can be obtained according to the parallax offset Xc(n). When the user interacts with the formed image lob(n) at the position and the distance, it means that the user wishes to trigger the procedure fcn(n) corresponding to the formed image lob(n). Accordingly, the user is enabled to perform 3D interactions with the 3D image played by the 3D display.

As previously discussed with reference to FIGS. 2A, 2B, 3A and 3B, accurate position and distance at which the user perceives the 3D image cannot be concluded solely based on the parallax offset between the left and right images, that is, appropriate interactions with the 3D environment may not be offered to the user. It is to be reminded that monitors with different sizes generate different parallax offsets of the 3D image as well as different distances. Further, the distance is also affected by a distance between the monitor and the user. According to the embodiment of the present invention, the actual distance and position of the formed image perceived by the user are sensed in the flow 100, so as to correct the functional relationship between the parallax offset and the distance/position of the formed image and to realize the 3D interaction of the flow 200.

For example, when the formed image lob(n) is formed at a different distance Y_actual due to factors described in FIGS. 2A, 2B, 3A and 3B instead of being formed at a due distance Y_expect according to the parallax offset Xc(n), the distance Y_actual may be calculated from the parallax offset Xc(n) according to the functional relationship established by the present invention. Thus, when the user wishes to interact (by sending out an interaction signal) at the distance Y_actual, it may be concluded that the user wishes to interact with the formed image lob(n). As a result, even when the distance Y_expect differs from the distance Y_actually sensed by the user, the expected distance Y_expect leaves no undesirable effects on the interaction accuracy, and the present invention is still able to offer the user with appropriate interactions.

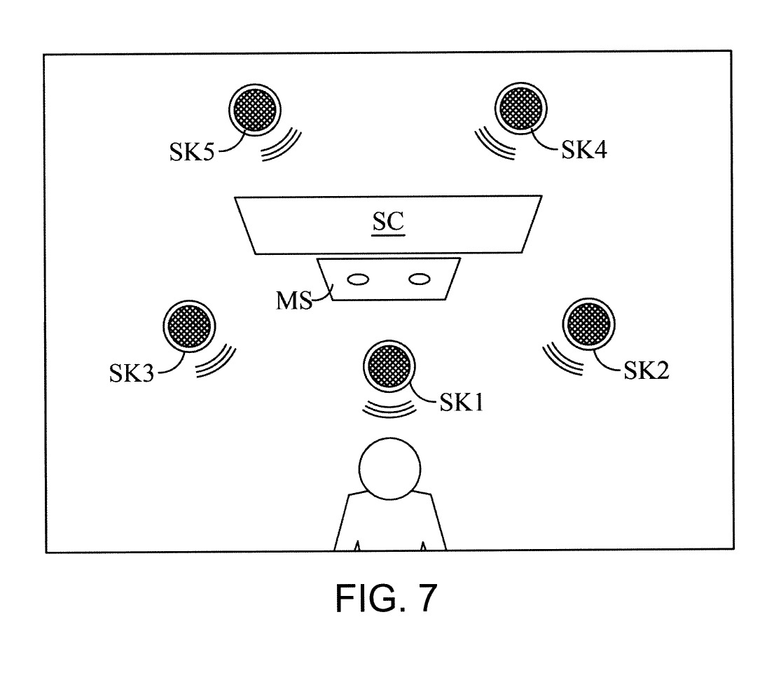

Apart from integrating sensing positioning with a 3D image, the present invention further integrates sensing positioning with a 3D sound field. FIG. 7 shows a schematic diagram of a surround sound field established by speakers SK1 to SK5 according to an embodiment of the present invention. In addition to the monitor SC and the sensor MS, the 3D display may also cooperate with the speakers SK1 to SK5 located at different positions to perform playback of surround audio effects. Image data of 3D display presents a 3D image via parallax offsets, whereas audio data of a surround sound field creates surround audio effects in a 3D virtual space according to offset information including offsets in frequency, phase, delay and/or volume, such that a user perceives by hearing a position of a virtual audio source. Similar to the difference between a distance of a formed 3D image established by the parallax offset and a distance the formed 3D image actually perceived by the user, the position of an audio source established by the audio effect offset information may also differ from the position of the audio source actually heard by the user. Hence, the present invention corrects a functional relationship between the audio effect offset information and the audio source position according to sensing and positioning by the sensor MS.

For example, the functional relationship between the parallax offset and the distance of the formed image is established in Step 106 of the flow 100. By directly utilizing the functional relationship, the method of the present invention adjusts/corrects audio effect offset information of audio data to match with the audio source position established by the audio effect offset information with the audio source position actually positioned by the user. Alternatively, similar to Steps 102 and 104, the present invention may also play test audio data to the user, and the audio source position heard is responded or indicated by the user to obtain test positioning information of the audio position provided by the user. According to the audio effect offset information of the test audio data and the test positioning information, a functional relationship between the audio effect offset information and the audio source positioning information may be established as in Step 106.

Similar to the flow 200, the present invention may also provide user interactions by utilizing the functional relationship between the audio effect offset information in the surround sound field and the audio source positioning information. For example, supposing audio data of an interactive audio source corresponds to audio effect offset information, the corresponding reference positioning may be obtained from the functional relationship. When the sensor MS senses the user action to provide the corresponding interaction positioning information, audio data of the interactive audio source is played supposing the interaction positioning information matches with the reference positioning information. Interactions of the surround sound field may cooperate with interactions of the 3D images to increase usage amusement. For example, a virtual bell is displayed by a 3D image. When the virtual bell is touched by the user, bell audio data of the virtual bell is played, with an audio source position of the sound being consistent with the formed image position of the virtual bell.

According to the functional relationship between the parallax offset in the 3D image data and the sensed positioning information, and/or the functional relationship between the audio effect offset information in the surround sound field audio data and the sensed positioning information, the method of the present invention is capable of adjusting the image data and the audio data, so that the distance of the formed 3D image established based on the parallax offset matches with the distance actually perceived by the user while the audio source position established based on the audio offset information also matches with the audio source position actually heard by the user.

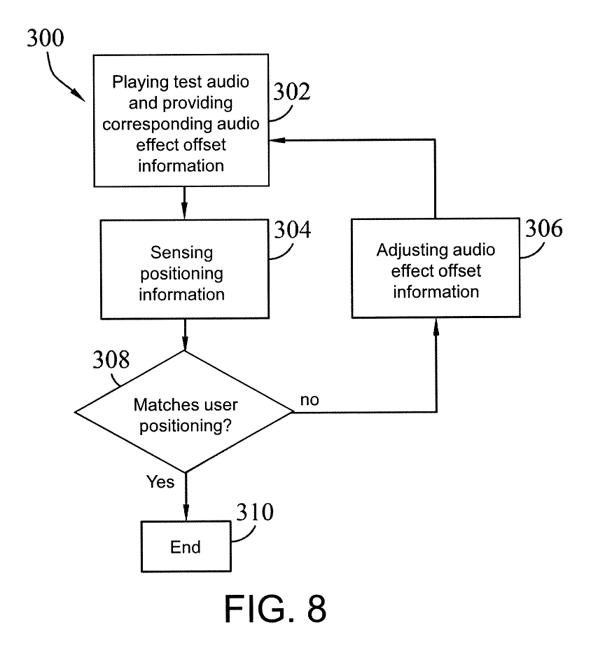

FIG. 8 shows a flowchart of a flow 300 for adjusting audio data according to an embodiment of the present invention.

In Step 302, test audio data is played. The test audio data establishes a surround audio effect according to corresponding test audio effect offset information.

In Step 304, the audio source of the test audio data is positioned by the user, and a positioning action or the user or positioning information responded by the user is sensed to serve as test positioning information.

In Step 306, the user-positioned audio source position in the test positioning information is compared with an audio position to be established by the test audio effect offset information to determine whether the two match with each other. When the two do not match (i.e., an error between the two exceeds a tolerable value), the flow 300 proceeds to Step 308; or else the flow 300 proceeds to Step 310 when the two match.

In Step 308, the test audio effect offset information of the test audio data is adjusted to change the audio source position established by the test audio effect offset information, followed by iterating Step 302. The test audio effect offset information is adjusted according to the functional relationship between the audio effect offset information and the audio source positioning information, so as to match the audio source position established by the test audio effect offset information with the user-positioned audio source position in the test positioning information. In equivalence, adjusting the test audio effect offset information is modifying playback parameters of the speakers. For example, the playback parameters are volume, delay, phase and/or frequency.

The flow 300 ends in Step 310.

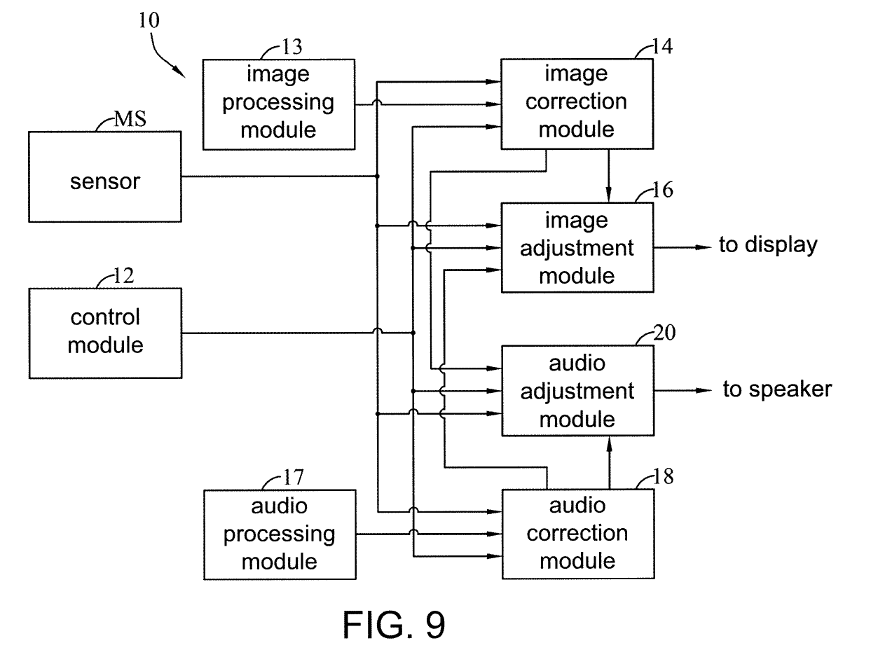

FIG. 9 shows a schematic diagram of an apparatus 10 according to an embodiment of the present invention. The apparatus 10 is applied in 3D display, and adjusts/corrects formed image/audio effect positions of a 3D image and audio data. The apparatus 10 comprises a control module 12, an image processing module 13, an image correction module 14, an image adjustment module 16, an audio processing module 18, an audio correction module 18 and an audio adjustment module 20. The control module 12 control operations of the other modules. Similar to Steps 102 and 104 in the flow 100, the image processing module 13 receives a test 3D image and obtains an associated predetermined parallax offset. The image correction module 14 receives the parallax offset of the test 3D image, and the sensor MS receives test positioning information corresponding to the parallax offset (i.e., user-positioned positioning information of the test 3D image). Accordingly, the image correction module 14 calculates a functional relationship (as in Step 106) according to the predetermined parallax offsets and corresponding test positioning information to associate different parallax offsets to the corresponding positioning information.

To display 3D display image data, the image adjustment module 16 adjusts an offset of the display image data according to operations of the image correction module 14. The image adjustment module 16 receives the display image data corresponding to display positioning information, which corresponds to one or a plurality of 3D images and represents an expected formation position of an object to be displayed. The image correction module 14 substitutes the display positioning information into the functional relationship to provide the corresponding display parallax offsets to be received by the image adjustment module 16. That is, to allow the user to perceive the formed 3D image at a position represented by the display positioning information, the parallax offset between the left and right images of the formed 3D image should match with the display parallax offset calculated by the image correction module 14. The image adjustment module 16 adjusts the parallax offsets in the display image data according to the display parallax offsets. With the size of the monitors being constant, the maximum adjustable parallax offset when generating the 3D image is limited. Therefore, in another embodiment, the display may send a command or information to prompt the user to slightly adjust the positioning thereof, so that the offset corresponding to the positioning information may be within a maximum value supported by the monitor.

For example, the 3D display image data displayed by the 3D display may be obtained by 3D virtual model real-time rendering. Therefore, parameters such as focuses and angles of the rendering are modified when performing the 3D virtual model rendering so that the formed 3D image may be located at the position assigned by the display positioning information. Alternatively, optical parameters (e.g., angle and direction) of the left and right images may be adjusted by the 3D display to adjust the parallax offset between the left and right images to further correct the distance of the formed 3D image.

Similar to operation principles of the image correction module 14, the audio processing module 17 receives predetermined audio effect offset information associated with test audio data. After playing the test audio data, the audio correction module 18 receives user-positioned test positioning information of the audio source with respect to audio effect offset information in the test audio data. The audio correction module 18 calculates a second functional relationship according to the audio effect offset information and the corresponding test positioning information to associate different audio effect offset information with the corresponding positioning information.

To play display audio data associated with the display image data, the audio correction module 18 substitutes the display positioning information corresponding to the display audio data to the second functional relationship to provide associated display audio effect offset information. The audio adjustment module 20 receives the display audio data, receives the display audio effect offset information provided by the audio correction module 18, and adjusts the audio effect offset of the display audio data according to the display audio effect offset information and/or display parallax offsets and/or the functional relationship of the image correction module 14. The audio data adjusted by the audio adjustment module 20 is outputted to a speaker (e.g., the speakers SK1 to SK5 in FIG. 7), so that an audio source position to be established by the display positioning information matches with an audio source position actually heard by the user. Similarly, the image adjustment module 16 also adjusts the display image data according to the display parallax offsets and/or display audio effect offset information and/or the second functional relationship of the audio correction module 18, and outputs the adjusted image to the 3D display, so that the formed 3D image position (the distance) to be established by the display positioning information matches with a position actually perceived by the user.

For example, the apparatus 10 is realized in a control chip of the 3D display; the image correction module 14, the image adjustment module 16, the audio correction module 18 and the audio adjustment module 20 are realized by software, firmware and/or hardware. It is to be noted that the audio correction module 18 and/or the audio adjustment module 20 are optional.

When displaying the interactive image lob(n) in the embodiment in FIG. 6, the expected distance Y_expect of the parallax offset Xc(n) may differ from the distance Y_actual of the actually formed image. Although the two distances may be different, the present invention is nevertheless capable of appropriately realizing 3d interaction. In the embodiment shown in FIG. 9, the present invention further adjusts the parallax offset to modify the distance Y_actual of the formed image, so that the expected distance Y_expect of the formed image equals the distance Y_actual actually sensed by the user. The embodiments shown in FIGS. 6 and 9 may be integrated.

In conclusion, the present invention integrates sensing position with 3D image/surround audio playback, so that not only the 3D playback matches with sensations of the user but also the user is able to appropriately interact with a virtual environment established by the 3D playback.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for a three-dimensional (3D) display, comprising:
generating a 3D image of a test object by the 3D display, the 3D image being associated with a predetermined parallax offset;
sensing a response signal associated with the 3D image from a user; and
sensing test positioning information associated with the user in response to the response signal;
wherein, the predetermined parallax offset and the test positioning information has a predetermined relationship.

2. The method according to claim 1, further comprising:
generating a plurality of 3D images of the test object, the 3D images being associated with a plurality of different predetermined parallax offsets;
sensing a plurality of response signals from a user;
sensing a plurality sets of test positioning information associated with the user; and
obtaining the predetermined relationship according to the predetermined parallax offsets and the plurality sets of the test positioning information, wherein the predetermined relationship is to describe different positioning information corresponding to different parallax offsets.

3. The method according to claim 1, further comprising:
generating a plurality of 3D images of a plurality of interactive objects by the 3D display, each 3D image corresponding to a second parallax offset;
providing a plurality sets of corresponding reference positioning information according to the second parallax offsets and the predetermined relationship;
sensing interaction positioning information of the user; and
comparing the interaction positioning information with the reference positioning information.

4. The method according to claim 3, further comprising:
sensing a response signal associated with the plurality of the 3D images from the user; and
sensing the interaction positioning information of the user after responding to the response signal.

5. The method according to claim 3, further comprising:
prompting the user to adjust a user position when a comparison result indicates the interaction positioning information does not match with the reference positioning information; and
sensing again interaction positioning information of the user.

6. The method according to claim 3, further comprising:
providing an interaction parallax offset according to the interaction positioning information of the user and the predetermined relationship when a comparison result indicates the interaction positioning information does not match with any of the reference positioning information; and
adjusting a second parallax offset of at least one of the 3D images of the interactive objects into the interaction parallax offset, so that the reference positioning information corresponding to the interaction parallax offset matches with the interaction positioning information of the user.

7. The method according to claim 3, further comprising:
associating each of the interactive objects with a predetermined procedure; and
when a comparison result indicates the interaction positioning information matches with one of the plurality sets of the reference positioning information, executing the predetermined procedure associated with the matching interactive object by the 3D display.

8. The method according to claim 1, further comprising:
capturing a user image to generate a plurality of sensed images; and
providing the test positioning information according to differences between the sensed images.

9. The method according to claim 8, further comprising:
performing focusing by utilizing the differences between the sensed images when generating the sensed images.

10. The method according to claim 1, wherein sensing the test positioning information of the user comprises:
transmitting a positioning wave to the user;
receiving a reflected wave of the positioning wave; and
generating the test positioning information according to the reflected wave.

11. The method according to claim 1, further comprising:
substituting display positioning information into the predetermined relationship when displaying a displayed object to provide a corresponding display parallax offset; and
displaying a 3D image of the displayed object by the 3D display according to the display parallax offset.

12. The method according to claim 1, the 3D display comprising a plurality of speakers, the method further comprising:
adjusting a plurality of playback parameters of the speakers according to the positioning information.

13. A method for a 3D display, comprising:
displaying a plurality of test 3D images, each test 3D image corresponding to a predetermined parallax offset; and
obtaining corresponding test positioning information according to a response signal from a user in response to each test 3D image.

14. The method according to claim 13, further comprising:
calculating a functional relationship according to each predetermined parallax offset and each test positioning information to associate different parallax offsets with the corresponding test positioning information.

15. The method according to claim 13, further comprising: obtaining display image data corresponding to display positioning information;
substituting the display positioning information into the functional relationship to provide a corresponding display parallax offset; and
adjusting the display image data according to the display parallax offset.

16. The method according to claim 13, further comprising:
playing a plurality of test audio data by the 3D display when displaying the test 3D images, each of the audio test data corresponding to each of a plurality sets of predetermined audio effect offset information;
calculating a functional relationship according to each set of predetermined audio effect offset information and each test positioning information, wherein the functional relationship is to describe the positioning information corresponding to different audio effect offset information.

17. The method according to claim 16, further comprising:
obtaining display audio data corresponding to the display positioning information;
substituting the display positioning information into the functional relationship to provide corresponding display audio effect offset information; and
adjusting the display audio data according to the display audio effect offset information.

18. The method according to claim 13, further comprising:
sensing a response of a user in response to the test 3D images by a sensor to obtain the test positioning information.

19. A 3D playback apparatus, comprising:
an image processing module, for receiving a predetermined number of test 3D images and obtaining an associated predetermined number of predetermined parallax offsets;
an image correction module, for receiving the predetermined parallax offsets, receiving test positioning information associated with a response of a user in response to the predetermined number of test 3D images, and calculating a functional relationship according to the predetermined parallax offsets and the test positioning information; and
an image adjustment module, for receiving display image data corresponding to second display positioning information and a corresponding second predetermined number of display parallax offsets, and adjusting the display image data according to the display parallax offsets.

20. The apparatus according to claim 19, further comprising:
an audio processing module, for receiving second predetermined audio effect offset information associated with the second predetermined test audio data and the predetermined number of test 3D images;
an audio correction module, for receiving the test positioning information, and calculating a second functional relationship according to the predetermined audio effect offset information and the test positioning information to associated different audio effect offset information to corresponding positioning information.
